(19) United States
(12) Patent Application Publication
(10) Pub. No.: US 2014/0353948 A1
(43) Pub. Date: Dec. 4, 2014

(54) VEHICLE ACCESSIBILITY SYSTEM

(71) Applicant: Jeffrey J. Hermanson, Culver, IN (US)

(72) Inventor: Jeffrey J. Hermanson, Culver, IN (US)

(21) Appl. No.: 14/292,510

(22) Filed: May 30, 2014

Related U.S. Application Data
(60) Provisional application No. 61/829,804, filed on May 31, 2013.

(51) Int. Cl. A61G 3/06; B62D 21/00; B60G 17/052

(52) U.S. Cl. CPC A61G 3/065; B60G 17/052; B62D 21/00
USPC 280/657; 280/43.17

(57) ABSTRACT

A system for facilitating access to a vehicle includes a vehicle frame and a plurality of wheels supported by a surface, wherein each wheel is coupled to a control arm coupled to the frame. A body is supported by the frame and defines a passenger compartment with a driver's side and a passenger side. A height adjustment assembly is positioned between each control arm and the associated wheel. A controller is operable to actuate each height adjustment assembly to raise and lower the frame and body between a raised position and a lowered position in which a portion of the frame contacts the surface.

### CROSS-REFERENCE TO RELATED APPLICATIONS

This application claims priority to co-pending U.S. Provisional Patent Application No. 61/829,804 filed on May 31, 2013, the entire content of which is incorporated herein by reference.

### FIELD OF THE INVENTION

The present invention relates to wheelchair accessible vehicles, and more particularly to an integrated vehicle accessibility system for driver or passenger side wheelchair ingress and egress.

### BACKGROUND OF THE INVENTION

Ramp systems are often used to facilitate entry to and exit from a vehicle interior by wheelchair-bound passengers. It is also desirable for wheelchair-bound drivers to be able to enter and exit a vehicle driver's side while remaining in a wheelchair and to be able to drive from such a position. To do so, however, requires an easily operable system that not only accommodates a wheelchair-bound driver but permits convenient, comfortable, and efficient vehicle ingress and egress in circumstances when the driver is traveling alone without additional assistance.

### SUMMARY OF THE INVENTION

In one embodiment, the present invention provides a vehicle with an integrated system for assisting a wheelchair-bound driver into and out of the vehicle. The vehicle includes a height adjustment assembly and a door assembly and is operable to lower from a driving height to a ground-level access height while a driver's side access platform concurrently extends from the vehicle. When fully extended, the platform is adjacent the ground such that the wheelchair-bound driver is able to wheel forward on to the platform. With push-button control, the vehicle rises back to the driving height while the access platform retracts, positioning the driver into a vehicle driving position.

In one embodiment a system for facilitating access to a vehicle includes a vehicle frame and a plurality of wheels supported by a surface, wherein each wheel is coupled to a control arm coupled to the frame. A body is supported by the frame and defines a passenger compartment with a driver's side and a passenger side. A height adjustment assembly is positioned between each control arm and the associated wheel. A controller is operable to actuate each height adjustment assembly to raise and lower the frame and body between a raised position and a lowered position in which a portion of the frame contacts the surface.

In one embodiment a method for facilitating access to a vehicle includes lowering a frame and body of the vehicle to a position in which a portion of the frame contacts a surface supporting one or more wheels of the vehicle. The method also includes linearly extending one of a driver's side door and a passenger side door laterally from the body, wherein a passenger compartment defined by the body is accessible. The method further includes linearly retracting the one of the driver's side door and passenger side door laterally toward the body. The method additionally includes raising the frame and body to a position suitable for operational movement of the vehicle

Other features and aspects of the invention will become apparent by consideration of the following detailed description and accompanying drawings.

### BRIEF DESCRIPTION OF THE DRAWINGS

FIG. 1 is a perspective view of a vehicle with a height adjustment assembly for transporting a person in a mobility device.

FIG. 2 is a perspective view of the vehicle of FIG. 1 in a slightly-lowered position, with a door assembly of the vehicle in a slightly-extended position.

FIG. 3 is a perspective view of the vehicle of FIG. 2 in a further-lowered position, with the door assembly in a further-extended position.

FIG. 4 is a perspective view of the vehicle of FIG. 3 in a fully-lowered position, with the door assembly in a fully-extended position.

FIG. 5 is a perspective view of the vehicle of FIG. 4, in which a wheelchair-bound driver is positioned to enter the vehicle.

FIG. 6 is a perspective view of the vehicle of FIG. 5, in which the driver is positioned on a platform of the door assembly.

FIG. 7 is a perspective view of the vehicle of FIG. 6 in a slightly-raised position, with the door assembly in a slightly-retracted position.

FIG. 8 is a perspective view of the vehicle of FIG. 7 in a further-raised position, with the door assembly in a further-retracted position.

FIG. 9 is a perspective view of the vehicle of FIG. 8 in a fully-raised position, with the door assembly in a fully-retracted position.

FIG. 10 is a perspective view of a platform of the door assembly in the fully-retracted position.

FIG. 11 is a perspective view of the platform of the door assembly of FIG. 10 in the fully-extended position.

FIG. 12 is a perspective view of the platform of the door assembly of FIG. 11 with a ramp in a deployed position.

FIG. 13 is a schematic view of the height adjustment and door assemblies of the vehicle of FIG. 1.

FIG. 14 is a flow chart of a method of controlling the height adjustment and door assemblies of the vehicle of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

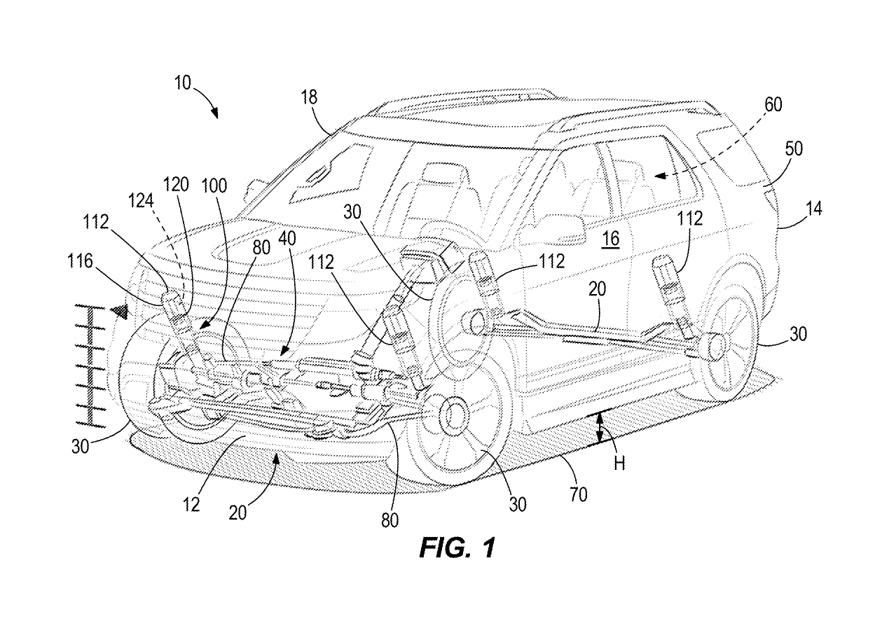

FIG. 1 illustrates an exemplary vehicle 10 for transporting a wheelchair-bound individual. The illustrated vehicle 10 is an SUV, but the accessibility system is not so limited in application and can be used with any van, SUV, light truck, or other consumer (or commercial) vehicle. In addition, while the embodiments disclosed hereafter will be described for use with a wheelchair, the accessibility system is applicable with any type of mobility device conventionally used to provide such assistance, to include motorized scooters, carts, and other wheeled and non-wheeled devices, e.g., a four-point walker.

With reference to FIG. 1, the vehicle 10 has a front end 12, a rear end 14, a driver's side 16, and a passenger side 18. The vehicle 10 also includes a frame 20 supported by four wheels 30, a suspension system 40 flexibly coupling the frame 20 to the wheels 30, and a body 50 supported by the frame 20. As opposed to body-on-frame, the vehicle 10 can be of a unibody construction. The suspension system 40 can be configured as a twin I-beam suspension, an independent suspension, or any other type of automotive suspension. The interior of the body 50 defines a passenger compartment 60 for accommodating a driver of the vehicle 10, one or more passengers, luggage, cargo, or other articles as may be desired. The wheels 30 contact a ground surface 70 (referred to herein as “the ground”) to support the frame 20 at a nominal height H above the ground 70 (also referred to as ground clearance). In the illustrated embodiment, the vehicle 10 has a ground clearance of about five inches during ordinary operation of the vehicle 10 (i.e., when driving at a constant speed on a level surface). In other embodiments, the vehicle 10 can have any other ground clearance.

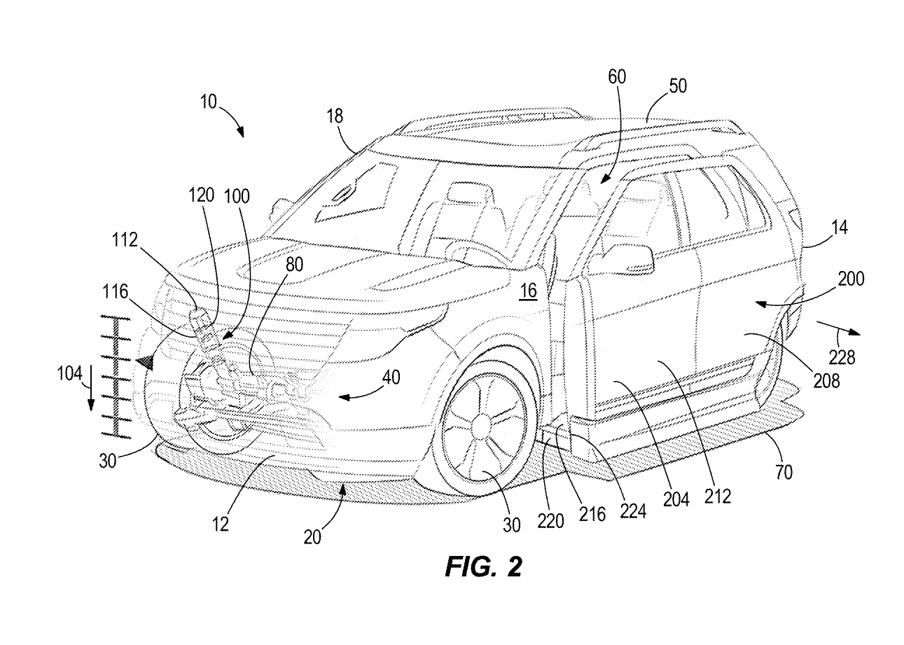

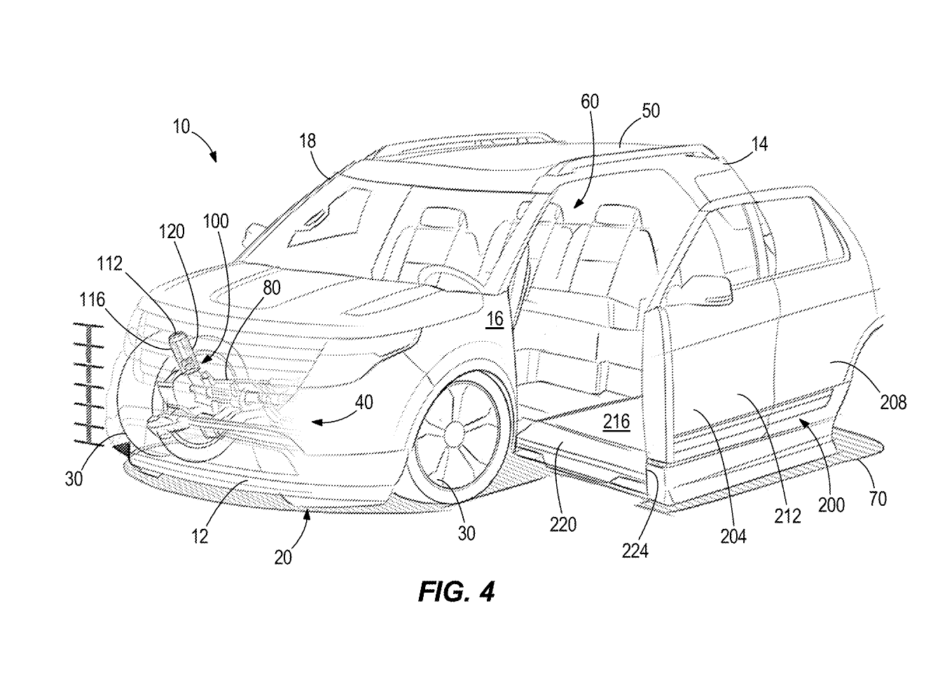

With reference to FIGS. 1-4, each of the wheels 30 is carried by a control arm 80 pivotally coupled to the frame 20 (FIG. 1). In a conventional vehicle (not shown), a spring and a shock absorber are disposed between each control arm and the frame for absorbing bumps and imperfections as the vehicle drives along the ground. The spring and the shock absorber can be integrally formed as a single unit or strut, such as a MacPherson strut. In the illustrated vehicle 10, the springs are replaced by a height adjustment assembly 100 operable to raise and lower the frame 20 and body 50 of the vehicle 10 between a fully-raised position (FIG. 1) and a fully-lowered position (FIG. 4). Specifically, the height adjustment assembly 100 is operable to move the frame 20 and body 50 relative to the ground 70 and wheels 30, generally in the directions of arrows 104 and 108 (FIGS. 2-3 and 7-8). In the fully-raised position, the frame 20 is disposed at the nominal height H. In the fully-lowered position, a contact portion (not shown) of the frame 20 comes to rest on the ground 70 (i.e., the ground clearance is zero).

With reference to FIG. 1, the height adjustment assembly 100 includes an actuator 112 associated with each of the wheels 30. The actuators 112 consist of a cylinder 116 and a piston 120 displaceable within the cylinder 116 between an extended position (FIG. 1) and a retracted position (FIG. 4) to move the vehicle 10 between the fully-raised position and the fully-lowered position. The piston 120 and the cylinder 116 define a working volume 124 that receives a pressure signal to actuate the piston 120 between the retracted position and the extended position. In the illustrated embodiment, the pressure signal is in the form of pressurized hydraulic fluid supplied by one or more hydraulic pumps. Alternatively, the pressure signal can be in the form of pressurized gas (e.g., air) supplied by one or more compressors. In such an alternative embodiment, the piston 120 and the cylinder 116 can be replaced by a bellows or air bag.

FIGS. 2-4 illustrate a door assembly 200 of the vehicle 10 that facilitates ingress and egress of the wheelchair-bound driver into a driver's position within the passenger compartment 60. Though described with respect to the driver side of the vehicle 10, the following embodiment is equally applicable and adaptable to the passenger side of the vehicle 10 for facilitating ingress and egress of a wheelchair-bound passenger. The door assembly 200 may therefore be associated with the driver side, the passenger side, or both the driver side and the passenger side of a vehicle 10.

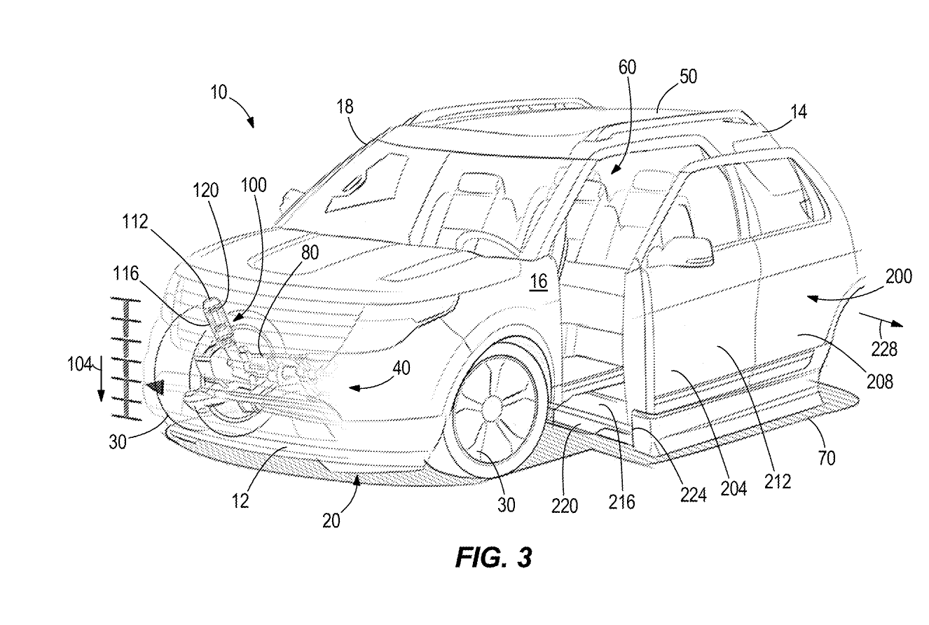

The door assembly 200 includes a front door 204 and a rear door 208 on the driver's side 16 of the vehicle 10 fixed together to form a single door unit 212. The front door 204 and the rear door 208 can be secured using fasteners or fusion bonding, or they can be integrally formed together as a single piece. The door assembly 200 further includes an access platform 216 slidably coupled to the frame 20 of the vehicle 10 by a track assembly 220. The door unit 212 is coupled to a first end 224 of the platform 216, which is laterally movable on the track assembly 220 between a fully-retracted position (FIG. 1) and a fully-extended position (FIG. 4), generally in the directions of arrows 228 and 232 (FIGS. 2 and 3). In the illustrated embodiment, the platform 216 moves in response to rotation of power screws, such as ball screws driven by one or more motors, such as stepper motors, powered by the electrical system of the vehicle 10 or by an auxiliary electrical system within the vehicle. Alternatively, the platform 216 can be moved by one or more hydraulic actuators, pneumatic actuators, or by any other suitable means.

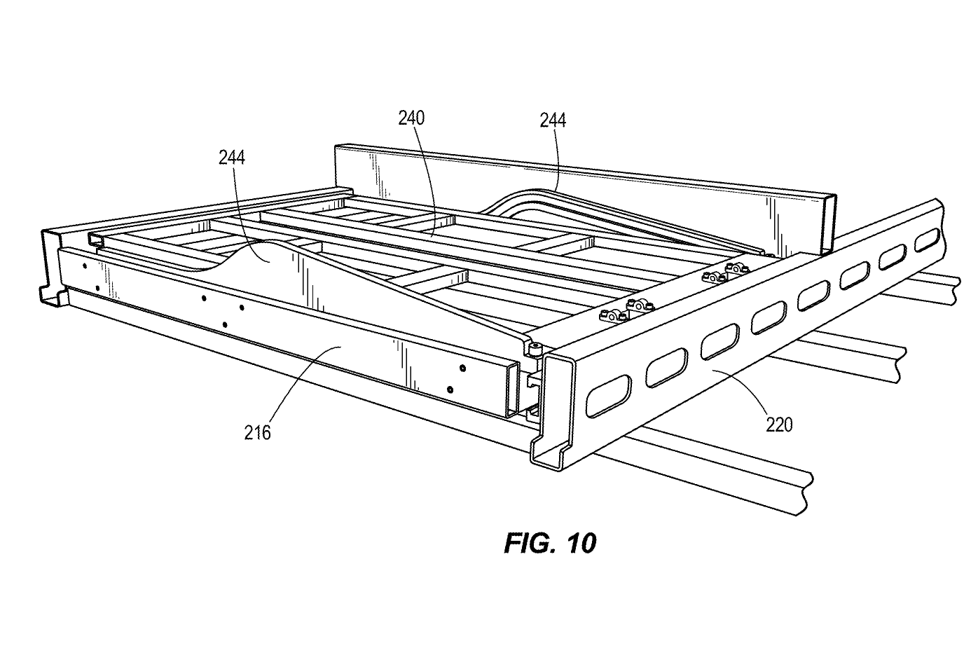

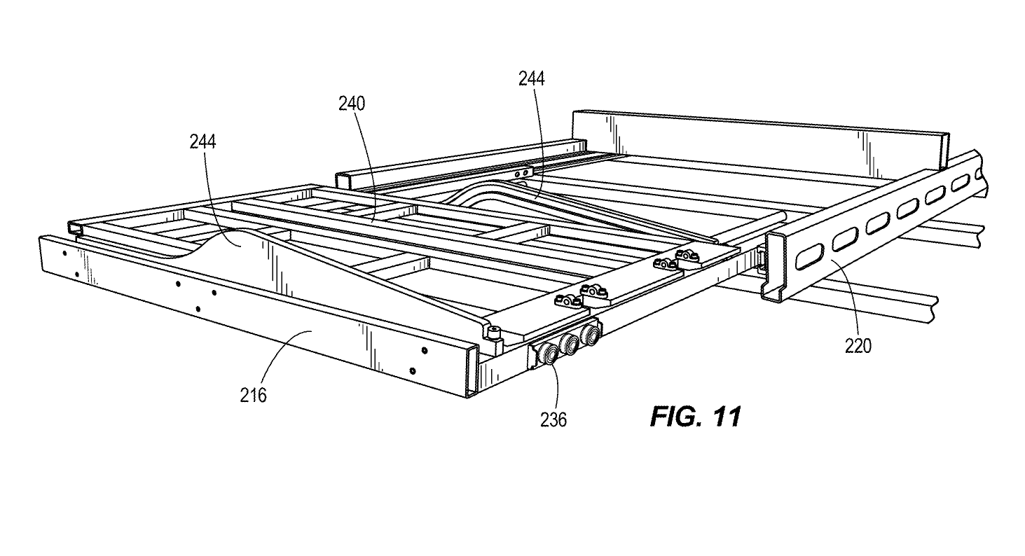

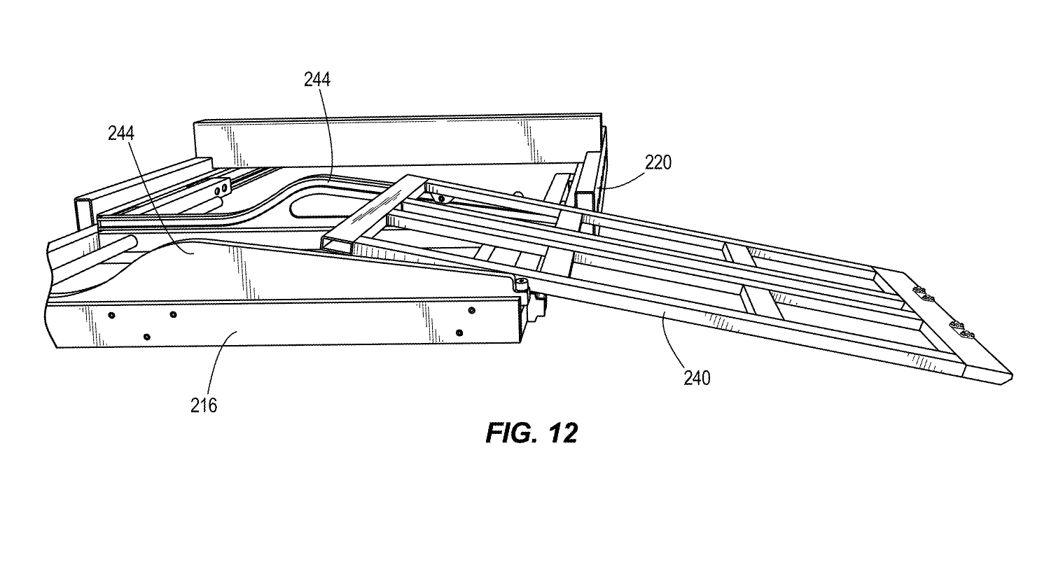

With reference to FIGS. 10-12, the track assembly 220 supports the platform 216 on rollers 236 to permit the platform 216 to slide smoothly between the fully-retracted position and the fully-extended position (FIGS. 10 and 11). The platform 216 has a generally rectangular shape and is sized to accommodate the driver's wheelchair. In the illustrated embodiment, the platform 216 includes a separate ramp 240 to facilitate wheelchair access on and off the platform 216. The ramp 240 has rollers (not shown) received within a pair of arcuate tracks 244 on the platform 216 to mount the ramp 240 to the platform 216 (FIG. 12). As such, the ramp 216 is movable between a stowed position (FIG. 11) and a deployed position (FIG. 12) along the contour of the arcuate tracks 244. A hydraulic or pneumatic actuator, one or more power screws, or any other suitable means can be provided to move the ramp 240 between the stowed position and the deployed position. In other embodiments, in lieu of a ramp 240, a smaller powered ramp may be operable near an edge of the platform 216 to assist the driver's transition from the ground directly on to the platform 216. Such a ramp may include or form “roll-stop” members (not shown) when retracted that are configured to abut the wheelchair positioned on the platform 216. In yet other embodiments, a transitional ramp may be integrally formed as part of the platform 216.

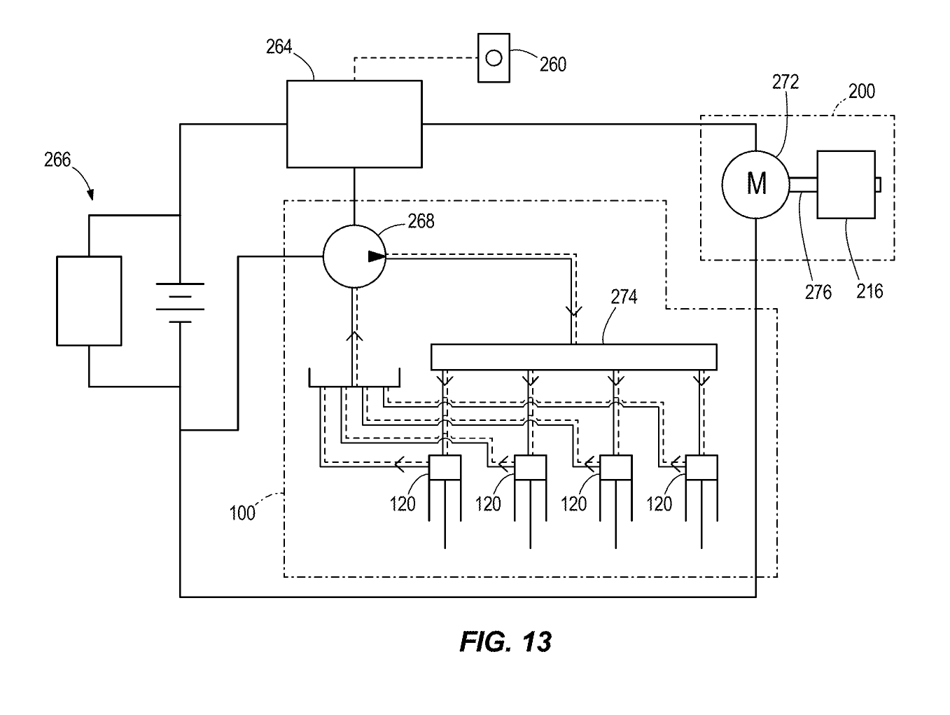

Referring to FIG. 13, the vehicle 10 further includes an activator 260, such as a push button, switch, lever, or the like, in communication with a controller 264 that governs operation of the height adjustment assembly 100 and the door assembly 200, both powered through the vehicle's electrical system 266. The activator 260 can be located for convenient access by the driver of the vehicle 10, such as in the passenger compartment 60, on the door unit 212, or remote from the vehicle 10 (e.g., on a wireless remote). In response to a signal from the activator 260, the controller 264 activates the hydraulic pump 268 and the stepper motors 272 (only one of which is illustrated in FIG. 13) to selectively raise and lower the frame 20 and body 50 of the vehicle 10 and to selectively extend and retract the door assembly 200.

With reference to FIGS. 1 and 13, the controller 264 can be configured to monitor a state of the height adjustment assembly 100. For example, in the illustrated embodiment, the controller 264 can monitor a working volume pressure of each actuator 112 to determine the relative position of the piston 120 in the cylinder 116. The controller 264 can use this information to determine a rate of extension or contraction for each of the actuators 112 (and thus the position of the frame 20), and then adjust the operation of the hydraulic pump 268 to correct any error in positioning. In some embodiments, each piston 120 can be actuated by a separate pump 268 or, as illustrated, a single pump 268 communicates with the pistons 120 through a common manifold 274. The controller 264 is also configured to monitor a state of the door assembly 200. For example, in the illustrated embodiment, the controller 264 monitors the current drawn by the stepper motors 272 to determine a torque experienced by the power screws 276. If the torque exceeds a predetermined value (indicative of a jam, an object in the path of the door assembly, the door assembly reaching the fully-extended position or the fully-retracted position, etc.), the controller 264 can reduce or stop operation of the stepper motors 272. The controller 264 can also monitor the number of revolutions of the motors 272 to determine a distance traveled by the door assembly 200 and therefore the position of the door assembly 200 between the fully extended and retracted positions. Other sensor inputs may be read by the controller 264 for positional determination of assemblies 100, 200. It should be understood that the controller 264 can perform other functions as may be desired.

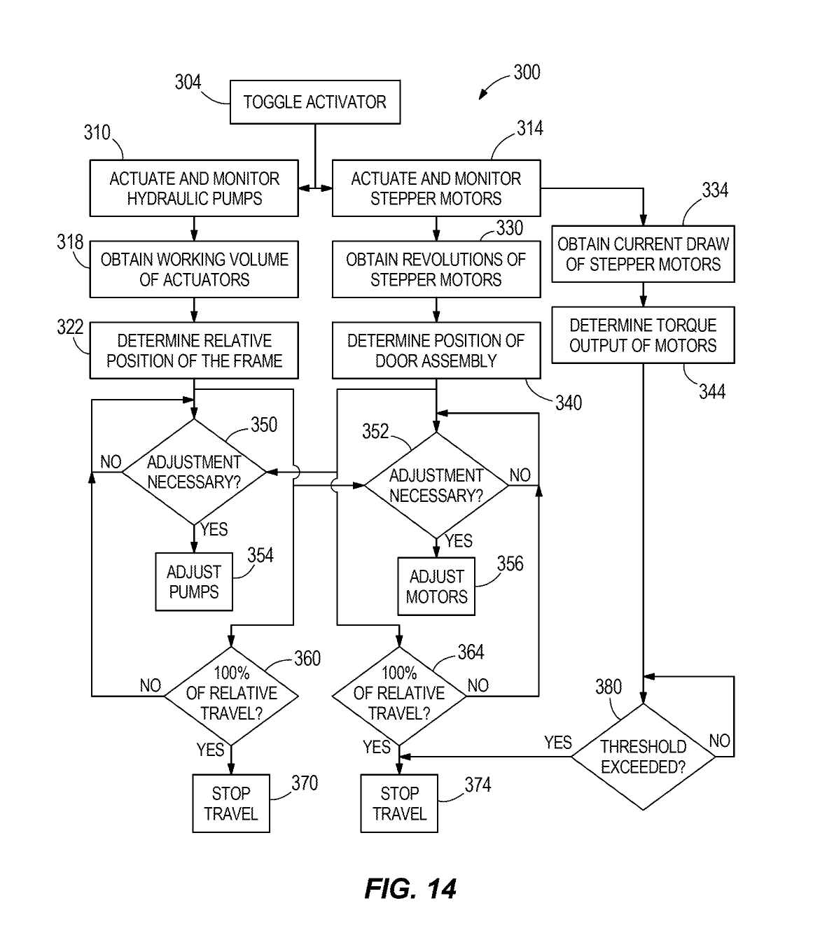

In operation, and referring to FIG. 14, to enter the vehicle 10, the wheelchair-bound driver toggles the activator 260 to initiate an access sequence 300, step 304. In response, the controller 264 activates and begins to monitor the hydraulic pump(s) 268, step 310. Each of the actuators 112 of the height adjustment assembly 100 begins to retract to lower the frame 20 and body 50 of the vehicle 10 from the fully-raised position toward the ground, in the direction of arrow 104 (FIGS. 2-3). As the frame 20 and body 50 are lowered, the controller 264 energizes and begins to monitor the stepper motors 272 to move the door assembly 200 laterally outward, in the direction of arrow 228, step 314. Energization of the stepper motors 272 can also occur simultaneously with, or slightly before, activation of the hydraulic pumps 268. In step 318, the controller 264 obtains a working volume of each actuator 112 and in step 322 determines the relative position of each piston 120 and therefore of the frame 20.

Concurrently, the controller 264 receives information on the revolutions and current draw of the stepper motors 272, steps 330, 334, and determines a relative position of the door assembly 200 and the torque output of the motors, steps 340, 344. The controller 264 continually monitors the position of the door assembly 200 with respect to the frame 20, steps 350, 352, and varies operation of the hydraulic pump(s) 268 and stepper motors 272, steps 354, 356, as necessary to maintain an approximate linear relationship between the travel of the frame 20 and the travel of the door assembly 200. As an example, when the frame 20 has lowered about 40% from the fully raised position, the door assembly 200 should be extended about 40% from the fully retracted position. The controller 264 synchronizes operation of the height adjustment assembly 100 and the door assembly 200 so that the door assembly 200 reaches the fully-extended position (100%) just before the vehicle 10 reaches the fully-lowered position (100%) (FIG. 4), steps 360, 364, at which point travel of the frame 20 and door assembly 200 is stopped, steps 370, 374. During movement of the door assembly 200, if the torque output of the motors 272 exceeds a certain threshold value during sequence 300, step 380, the controller 264 will reduce or cease operation of the motors 272 (step 374). In a preferred embodiment, the height adjustment assembly 100 lowers the vehicle 10 all the way to the ground to make it as easy as possible for the wheelchair-bound driver to roll onto the platform 216.

Alternatively, the controller 264 can energize the stepper motors 272 to move the door assembly 200 to the fully-extended position prior to lowering the frame 20 and body 50. In other embodiments, the controller 264 can operate the door assembly 200 and the height adjustment assembly 100 using any desired combination of independent and synchronized movements in the directions of arrows 104 and 228.

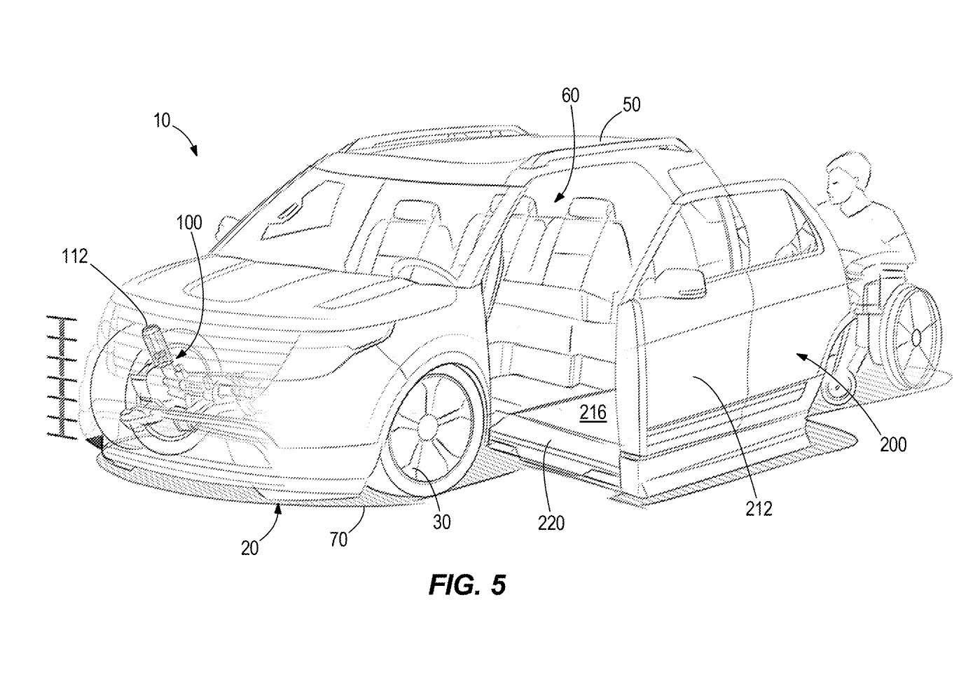

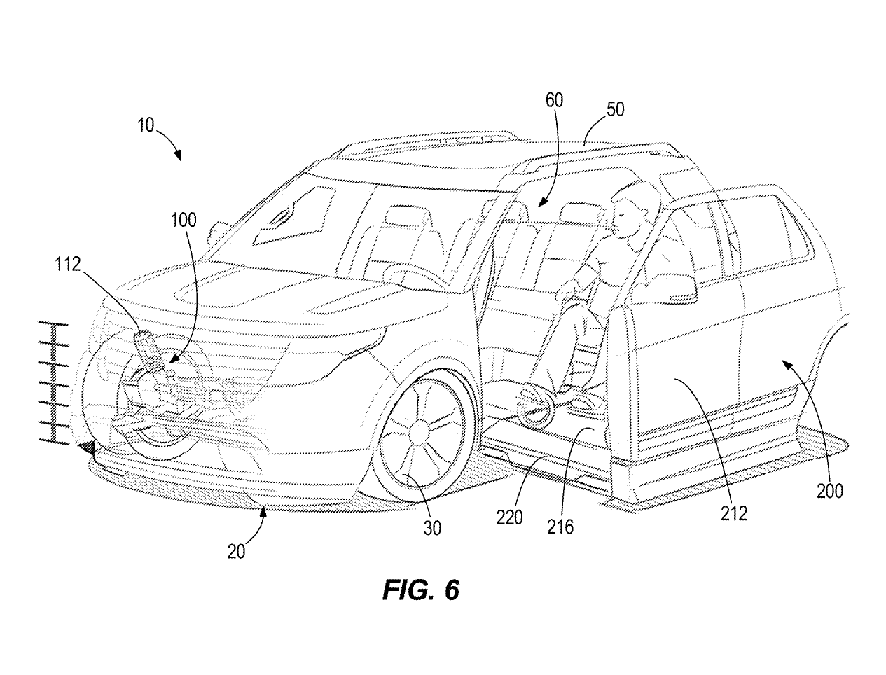

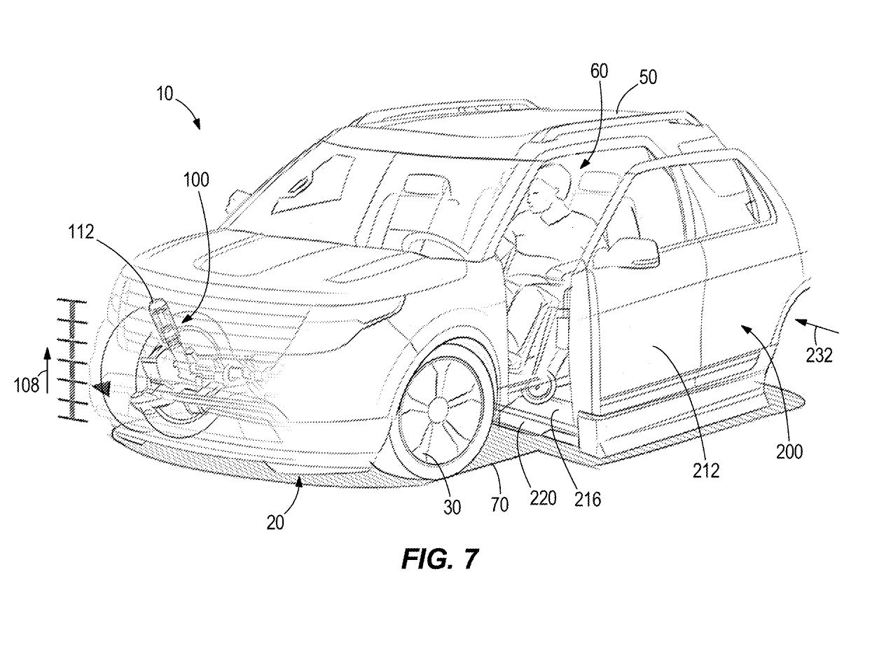

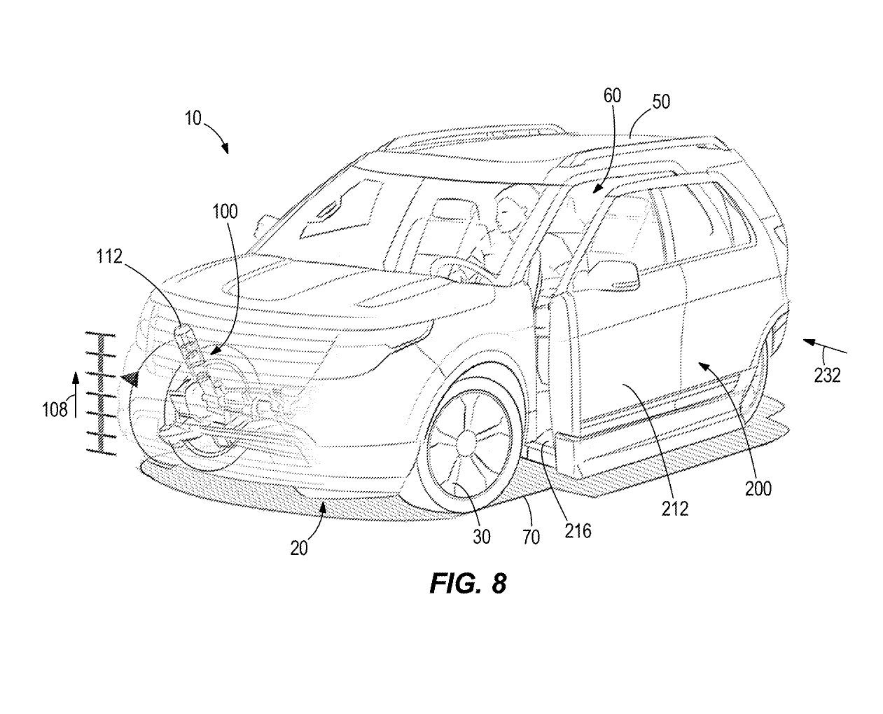

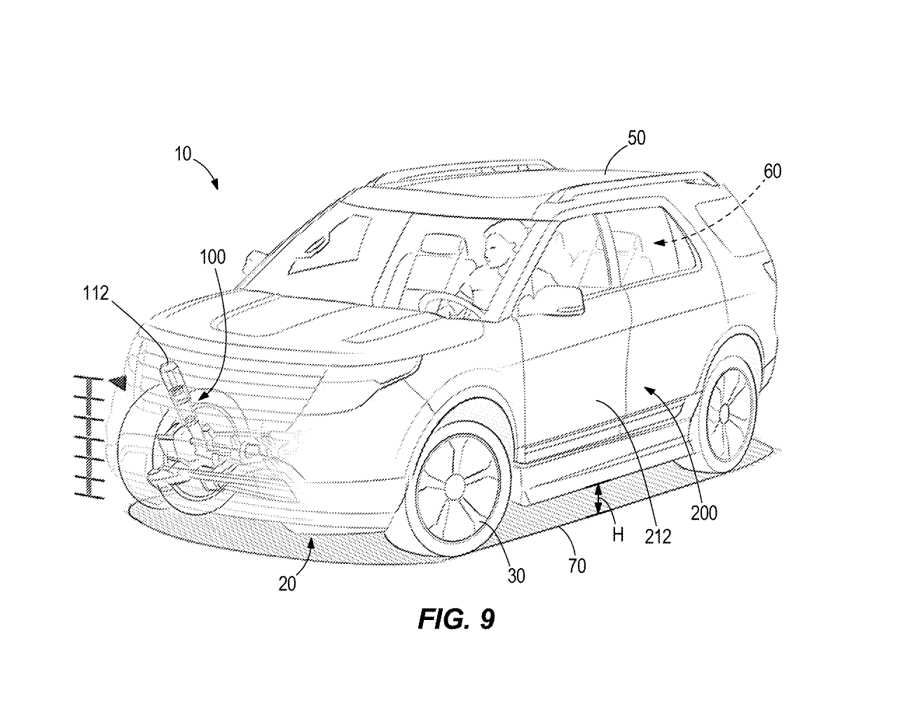

With reference to FIG. 5, once the vehicle 10 is in the fully-lowered position and the door assembly 200 is in the fully-extended position, a ramp, if used, moves to the deployed position to facilitate wheelchair access on to the platform 216. Because the frame 20 of the vehicle 10 is in contact with the ground, the angle of entry onto the platform 216 is at a minimum, which in turn requires a minimum amount of alignment and maneuvering on the part of the wheelchair-bound driver as he moves forward onto the platform 216 (FIG. 6). Once positioned on the platform 216, the driver again toggles the activator 260. In a sequence analogous to that of FIG. 14, the controller 264 activates the hydraulic pumps 268 to extend the actuators 112 of the height adjustment system 100, raising the frame 20 and body 50 off the ground in the direction of arrow 108 (FIGS. 7 and 8), and simultaneously energizes the stepper motors 272 in reverse to move the door assembly 200 laterally inward, in the direction of arrow 232. The driver remains positioned on the platform 216 and moves with the platform 216 into the passenger compartment 60 of the vehicle 10. The controller 264 synchronizes the height adjustment assembly 100 and the door assembly 200 so that the door assembly 200 reaches the fully-retracted position as the vehicle 10 reaches the fully-raised position (FIG. 9). Alternatively, the controller 264 can energize the stepper motors 272 to move the door assembly 200 to the fully-retracted position prior to raising the frame 20 and body 50 to the fully-raised position. In other embodiments, the controller 264 can operate the door assembly 200 and the height adjustment assembly 100 using any desired combination of independent and synchronized movements in the directions of arrows 108 and 232. When the vehicle 10 is in the fully-raised position and the door assembly 200 is in the fully-retracted position, the driver is properly positioned to operate the vehicle 10.

To exit the vehicle 10, the steps described above are reversed. The driver toggles the activator 260 to lower the vehicle 10 and extend the door assembly 200, allowing the driver to quickly and efficiently exit the vehicle 10. The driver has the option of exiting the platform 216 either forwardly or rearwardly, as desired.

The adjustment and door assemblies 100, 200 allow the driver to remain within the wheelchair in a forward-facing position during the entire entry sequence into the vehicle 10, while driving, and during the entire exit sequence from the vehicle 10.

Various features and benefits of the invention are included in the following claims.

What is claimed is:

1. A system for facilitating access to a vehicle, the system comprising:
a vehicle frame:
a plurality of wheels supported by a surface, wherein each wheel is coupled to a control arm coupled to the frame;
a body supported by the frame and defining a passenger compartment with a driver's side and a passenger side;
a height adjustment assembly positioned between each control arm and the associated wheel; and
a controller operable to actuate each height adjustment assembly to raise and lower the frame and body between a raised position and a lowered position in which a portion of the frame contacts the surface.

2. The system of claim 1, wherein the frame and body are of a unibody construction.

3. The system of claim 1, wherein each height adjustment assembly comprises an actuator including a piston displaceable within a cylinder between an extended position and a retracted position to move the frame and body between the raised position and the lowered position.

4. The system of claim 3, wherein the actuator is configured to receive a signal in the form of pressurized hydraulic fluid.

5. The system of claim 1, wherein each height adjustment assembly comprises an actuator including an air bag, the volume of which is adjustable to move the frame and body between the raised position and the lowered position.

6. The system of claim 5, wherein the actuator is configured to receive a signal in the form of pressurized gas.

7. The system of claim 1, further including a platform slidably coupled to the frame by a track assembly and movable between a retracted position in which the platform is positioned within the body and an extended position in which at least a portion of the platform is laterally displaced from the body.

8. The system of claim 7, further including a power screw, wherein the platform is movable via actuation of the power screw.

9. The system of claim 7, wherein the platform is fixedly coupled to a driver's side door, a passenger side door, or both.

10. The system of claim 7, wherein the platform includes a track and a ramp slidable along the track and extendable from the platform.

11. The system of claim 10, wherein the ramp is hydraulically or pneumatically actuated to an extended position from the platform.

12. A method for facilitating access to a vehicle, the method comprising:
lowering a frame and body of the vehicle to a position in which a portion of the frame contacts a surface supporting one or more wheels of the vehicle;
linearly extending one of a driver's side door and a passenger side door laterally from the body, wherein a passenger compartment defined by the body is accessible;
linearly retracting the one of the driver's side door and passenger side door laterally toward the body; and
raising the frame and body to a position suitable for operational movement of the vehicle.

13. The method of claim 12, wherein lowering the frame and body means actuating a height adjustment assembly disposed between a control arm coupled to the frame and one of the one or more wheels and the one of the one or more wheels.

14. The method of claim 13, wherein actuating a height adjustment assembly means displacing a piston within a cylinder using hydraulic fluid.

15. The method of claim 13, wherein actuating a height adjustment assembly means adjusting the volume of an air bag using pressurized gas.

16. The method of claim 12, wherein linearly extending one of a driver's side door and a passenger side door laterally from the body means extending a platform slidably coupled to the frame and affixed to the one of a driver's side door and a passenger side door.

17. The method of claim 12, further including monitoring a position of the one of a driver's side door and a passenger side door with respect to the lowering of the frame.

18. The method of claim 17, wherein the monitoring includes maintaining an approximately linear relationship between the lowering of the frame and the extending of the one of a driver's side door and a passenger side door.

19. The method of claim 16, further comprising extending a ramp from the platform in a direction orthogonal to a direction defined by the extending of the platform.
